(19) United States
(12) Patent Application Publication
(10) Pub. No.: US 2016/0237876 A1
(43) Pub. Date: Aug. 18, 2016

(54) AIR-COOLED ENGINE AND ENGINE WORKING MACHINE

(71) Applicant: HITACHI KOKI CO., LTD., Tokyo (JP)

(72) Inventors: Naoto ICHIHASHI, Ibaraki (JP); Takefumi KAWAGUCHI, Ibaraki (JP); Jun KUGENUMA, Ibaraki (JP)

(21) Appl. No.: 15/027,225

(22) PCT Filed: Dec. 4, 2014
(86) PCT No.: PCT/JP2014/006069

§ 371 Date: Apr. 4, 2016

(30) Foreign Application Priority Data
Dec. 4, 2013 (JP) 2013-250914

(51) Int. Cl. F01P 1/06; F01P 5/04; F02B 75/02; F01P 1/02; F01N 1/14; F02B 63/02

(52) U.S. Cl. CPC F01P 1/06; F01N 1/14; F02B 63/02; F02B 75/02; F01P 1/02; F01P 5/04; F02B 2075/025; F01P 2001/023

(57) ABSTRACT

An air-cooled engine includes a muffler that is attached to an exhaust port of a cylinder and a fan case that houses a cooling fan, and a cylinder cooling room is formed by a cylinder cover that houses the cylinder. A muffler cooling room is formed by a first muffler cover that covers at least some of the muffler through a clearance and a second muffler cover that covers at least some of the first muffler cover through a clearance. Some of cooling air generated by the cooling fan is supplied to the muffler cooling room. The cooling air is supplied to at least one of a first space between the muffler and the first muffler cover and a second space between the first muffler cover and the second muffler cover.

### TECHNICAL FIELD

The present invention mainly relates to an air-cooled engine used as a power source for a portable working machine such as a brush cutter and an air blower and for a working machine such as a generator, and in particular to a cooling structure for the air-cooled engine.

### BACKGROUND ART

A small-sized air-cooled engine is widely used as a power source for a small-sized working machine such as a brush cutter and a chain saw. FIG. 11 is a perspective view illustrating an outline of a brush cutter 101 as one example of an engine working machine. As illustrated in FIG. 11, a small-sized air-cooled engine 110 is mounted in the engine working machine. The engine working machine includes a hollow main pipe 105, and an engine 110 is provided on one end of the main pipe 105, and a rotary blade 106 is provided on the other end of the main pipe 105. A driving shaft (not illustrated) is built inside the main pipe 105. By rotating the driving shaft by the engine 110, the rotary blade 106 is rotated. In the vicinity of the rotary blade 106, a scatter protection cover 106a for preventing scattering of cut glass is provided on the other end of the main pipe 105. The engine working machine 101 is carried by an operator through a shoulder suspending belt (not illustrated) etc. A handle 104 that is operated by an operator is attached in the vicinity of a longitudinal center portion of the main pipe 105. The handle 104 is formed in substantially a U shape in a front view. A rotation speed of the engine is controlled by the operator through a throttle lever 107 attached to the vicinity of a grip portion 103. Operation of the throttle lever 107 is transmitted to a throttle valve in a carburetor of the engine through a throttle wire 118. In the vicinity of a distal end 129 of the grip portion 103, a switch (not illustrated) for stopping the engine 110 is provided.

In the small-sized air-cooled engine used as a power source for a portable working machine such as a brush cutter and a chain saw and for a working machine such as a generator, a cooling fan is provided on one end of the driving shaft, and a cooling air path is formed by a cover that covers the cooling fan and the engine body. In the cooling air path, cooling air flows from the cooling fan side to the opposite side of the cooling fan. A muffler is attached to a cylinder and the cylinder is covered with a muffler cover 136 that forms a muffler cooling room of the muffler. For example, in the engine working machine described above, gas exhausted from a muffler and air after cooling of a cylinder are exhausted to a rear side that is an opposite side of a position of an operator with respect to the engine 110. However, since a high-temperature exhaust gas flows inside the muffler, a surface of the muffler becomes a high temperature (for example, 300 to 500 degrees C.). Therefore, the muffler cover 136 is likely to receive heat damages such as erosion due to receiving radiation heat from the muffler and heat by natural convection. In particular, in a visible region from the outside, the heat damages (such as burnt, discoloration and transformation) result in an appearance defect, therefore, there has been a problem that the product value is remarkably deteriorated.

To deal with such a problem, as disclosed in Patent Literature 1, a muffler and a muffler cover are cooled by supplying cooling air to a space between the muffler and the muffler cover, thereby reducing the heat damages such as erosion.

### CITATION LIST

### Patent Literature

### PTL 1: Japanese Patent Application Laid-Open Publication No. 2013-068140

### SUMMARY OF INVENTION

### Technical Problem

However, although the cooling air is supplied to the space between the muffler and the muffler cover, a temperature cannot be sufficiently reduced, in particular, on an outer surface of the muffler cover because the cooling air also becomes a high temperature due to absorption of heat in the muffler by the time that the muffler is cooled. As a result, there has been a problem that the effect for reducing the heat damages is not sufficient.

It is an object of the present invention to provide a cooling structure capable of reducing the heat damages and preventing deterioration of the product value by sufficiently cooling a muffler cover, in particular, the temperature on an outer surface of the muffler cover along with a muffler, in the small-sized air-cooled engine that supplies the cooling air to the space between the muffler and the muffler cover.

### Solution to Problem

An air-cooled engine of the present invention includes: a cylinder; a crank case that is attached to the cylinder and rotatably supports a driving shaft; a cooling fan that is attached to the driving shaft; a muffler that is attached to an exhaust port of the cylinder and exhausts exhaust gas passing inside from an exhaust exit; a fan case that covers the cooling fan; a cylinder cover that covers the cylinder to form a cylinder room; and a muffler cover that covers the muffler to form a muffler room, and the air-cooled engine is characterized in that the muffler cover includes a first muffler cover that covers at least some of the muffler and a second muffler cover that covers at least some of the first muffler cover, and some of cooling air generated by the cooling fan is supplied to at least one of a first space between the muffler and the first muffler cover and a second space between the first muffler and the second muffler cover, and an air guiding portion is provided inside the muffler cover, the air guiding portion guiding cooling air that is supplied to the first space or the second space to an exhaust exit side of the muffler.

### Advantageous Effect of Invention

A small-sized air-cooled engine includes a first muffler cover that covers at least some of a muffler through a clearance and a second muffler cover that covers at least some of the first muffler cover through a clearance. A muffler cooling room is formed by the first muffler cover and the second muffler cover, and some of cooling air generated by a cooling fan is supplied to the muffler cooling room. Since the cooling air is supplied to at least one of a first space between the muffler and the first muffler cover and a second space between the first muffler cover and the second muffler cover, the muffler, the first muffler cover and the second muffler cover can be cooled by the cooling air, while the second muffler cover is protected from radiation heat by the muffler. Since the cooling air is guided in an exhaust direction of exhaust gas from the muffler by an air guiding portion, it is possible to effectively reduce heat damages of the second muffler cover.

### BRIEF DESCRIPTION OF DRAWINGS

FIG. 1 is an exploded perspective view of a small-sized air-cooled engine according to an embodiment of the present invention,

FIG. 2 is a front view of the small-sized air-cooled engine according to an example of the present invention,

FIG. 3 is a right side view of FIG. 2,

FIG. 4 is a cross-sectional view taken along the line C-C of FIG. 3,

FIG. 5 is a cross-sectional view taken along the line B-B of FIG. 2,

FIG. 6 is a cross-sectional view taken along the line A-A of FIG. 2,

FIG. 7 is a perspective view illustrating an inner surface of a second muffler cover illustrated in FIG. 1,

FIG. 8 is a perspective view illustrating an inner surface of a third muffler cover illustrated in FIG. 1,

FIG. 9 is a perspective view illustrating an inner surface of a first muffler cover illustrated in FIG. 1,

FIG. 10 is a perspective view of a divider plate illustrated in FIG. 1, and

FIG. 11 is a perspective view illustrating an appearance of a brush cutter as an engine working machine.

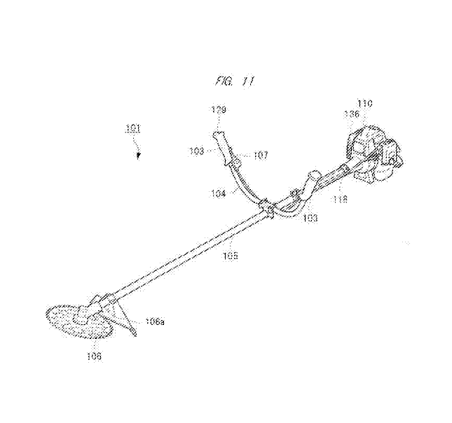

### DESCRIPTION OF EMBODIMENTS

A structure of an air-cooled engine (engine) that is an embodiment of the present invention will be described. Herein, the air-cooled engine includes a two-stroke engine body having a cylinder, a crankcase, etc. and a cylinder cover that covers the cylinder, etc. In the engine body, a cooling fan is fixed to a driving shaft, and the cylinder is cooled in the cylinder cover by cooling air generated by rotation of the cooling fan. Further, in the cylinder, a plurality of radiation fins are formed on an outer surface of a cylinder portion formed in substantially a cylinder shape, and a combustion chamber is formed inside the cylinder portion.

This engine is applied to a portable working machine, such as a brush cutter and an air blower, carried by an operator, and the engine having the above structure is mounted in the engine working machine. Therefore, practically, a reducer, etc. for driving the engine working machine are connected to a driving shaft, and the structures for fixing the engine to the engine working machines (for example, operation tube, handle and cutting blade of brush cutter) are provided in the engine.

However, the connection structures between the engine and the engine working machines are not directly related to the present invention, and such structures are the same as those conventionally known. Therefore, the explanation of such structures will be omitted, but the structures and functions relating to cooling of the engine will be mainly described.

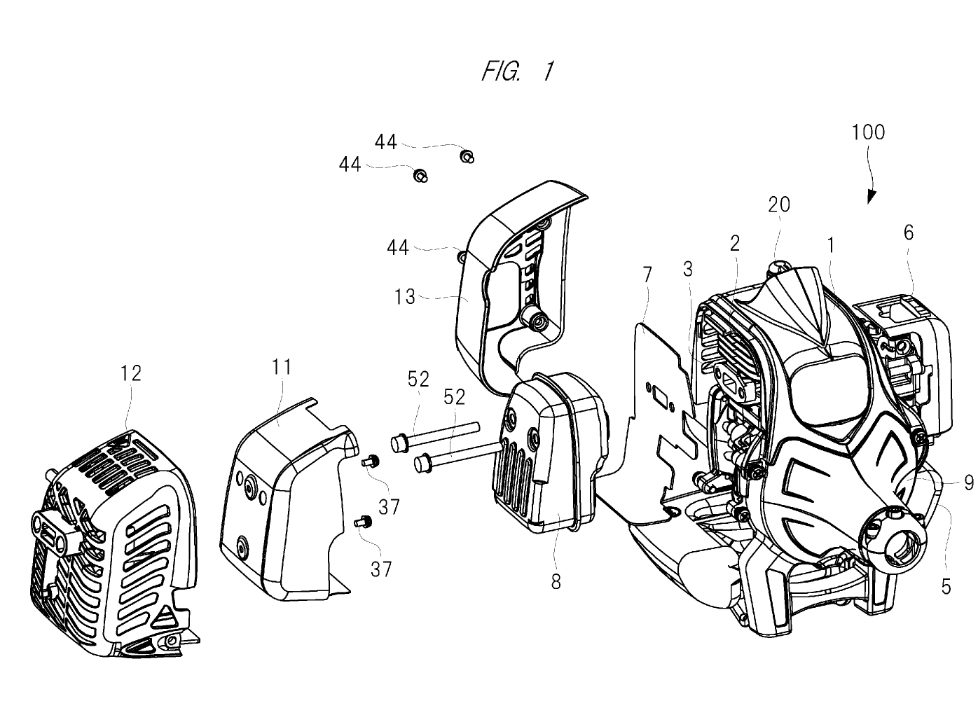

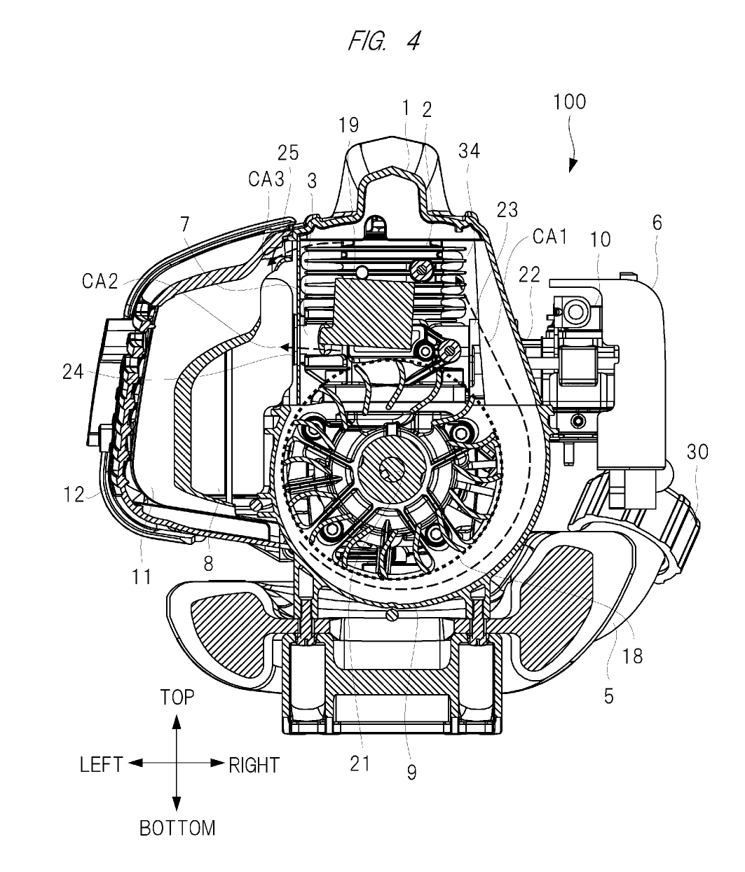

FIG. 1 is an exploded perspective view of a small-sized air-cooled engine (engine) 100 according to an embodiment of the present invention. The engine 100 includes a crankcase 4 that rotatably supports a driving shaft 21, and a cylinder 2 is provided at an upper part of the crankcase 4. An upper part of the cylinder 2 is covered with a cylinder cover 1. A piston 17, etc. (not illustrated in FIG. 1) are provided inside the cylinder 2, and in a surface of the cylinder 2, a plurality of fins are arranged in substantially parallel in a vertical direction, so as to enhance cooling efficiency. An ignition plug (not illustrated) for igniting air-fuel mixture in the cylinder 2 is provided at an upper part of the cylinder 2, and a plug cover 20 is attached to the ignition plug. The ignition plug is electrically connected to an ignition device 19 (FIG. 4) attached to the cylinder 2 by a high-tension code (not illustrated), and the ignition plug emits sparks inside the cylinder 2 by operation of the ignition device 19. A cooling fan 18 is fixed to the driving shaft 21 that is driven in the engine 100, thereby generating cooling air.

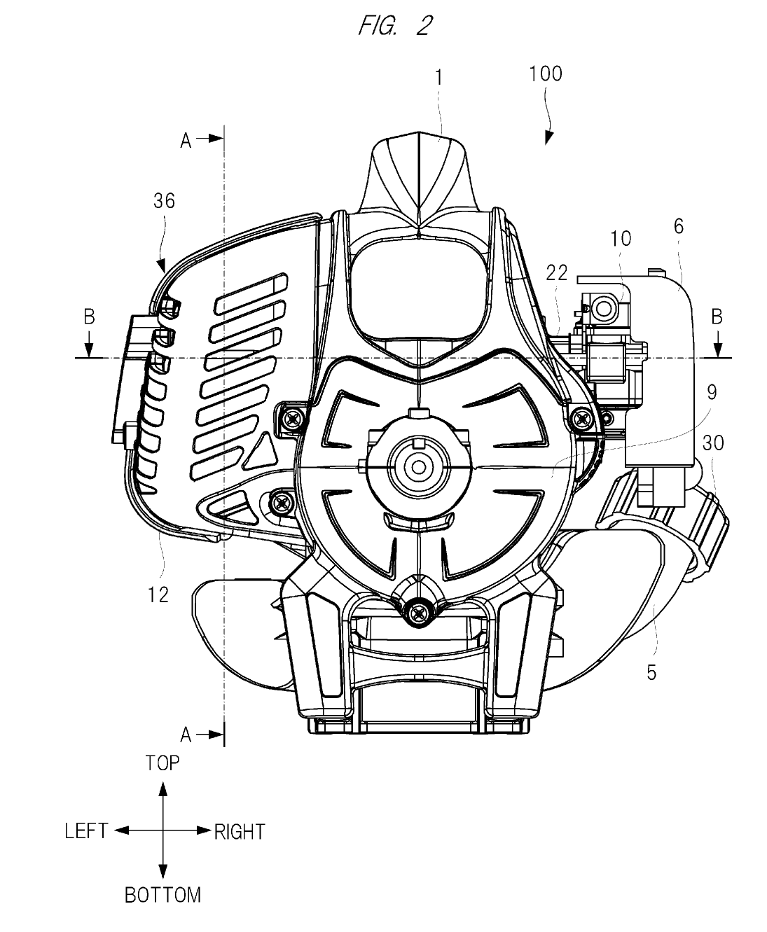

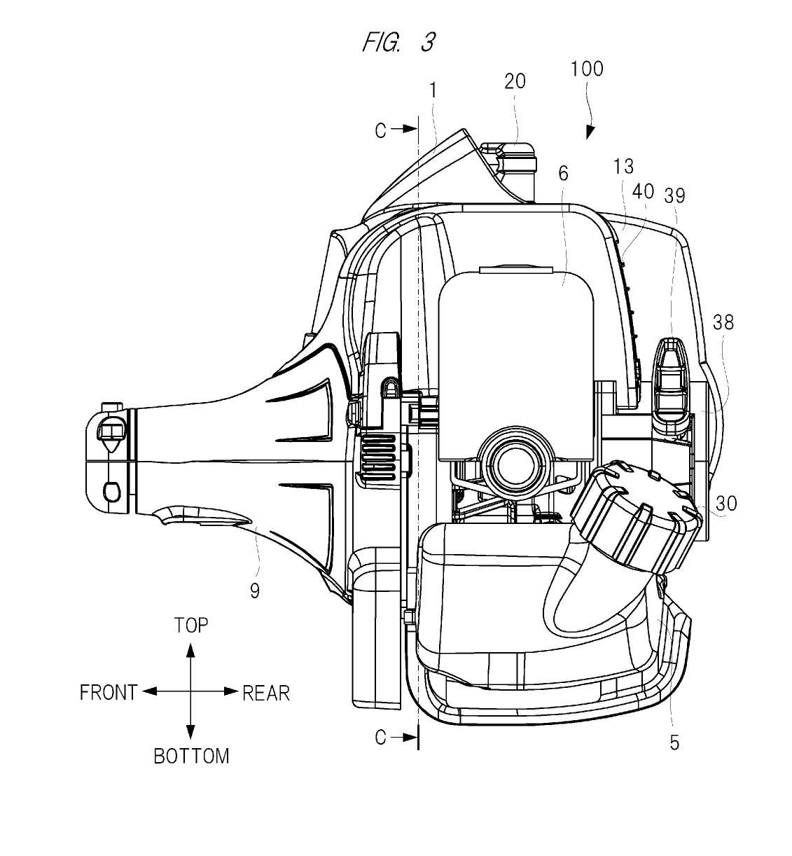

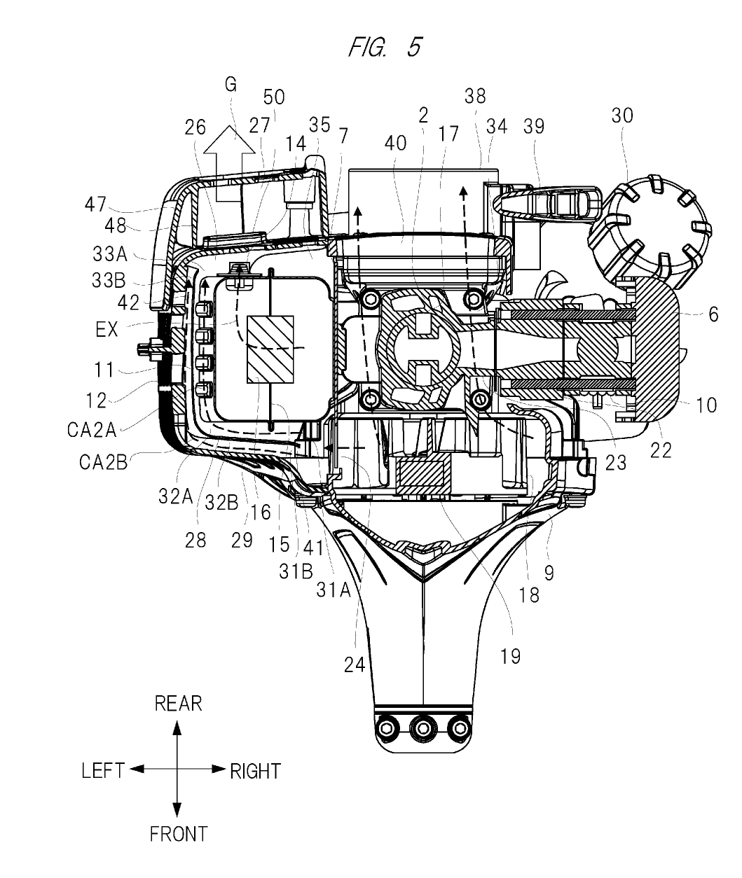

FIG. 2 is a front view of the engine 100, FIG. 3 is a right side view of FIG. 2, FIG. 4 is a cross-sectional view taken along the line C-C of FIG. 3, and FIG. 5 is a cross-sectional view taken along the line B-B of FIG. 2.

At a lower part of the crankcase 4, a fuel tank 5 in which fuel is accumulated is attached. An intake port 23 for guiding the air-fuel mixture in which the fuel and air are mixed into the cylinder 2 is provided on the right side of the cylinder 2 when seen from the front. An intake tube 22 is attached to the intake port 23, and a carburetor 10 that generates the air-fuel mixture is also attached to the intake port 23. Further, an air cleaner 6 is fixed to the right side of the carburetor 10, so as to remove dust, etc. in air that is guided into the carburetor 10. The air cleaner 6 is fixed in a state that a filter element (not illustrated) for removing dust, etc. is housed. The carburetor 10 and the fuel tank 5 are connected to each other by a fuel passage (not illustrated) formed of rubber tube, etc., and the fuel is supplied to the carburetor. The fuel is supplied to the fuel tank 5 by removing a tank cap 30 attached to a fill opening.

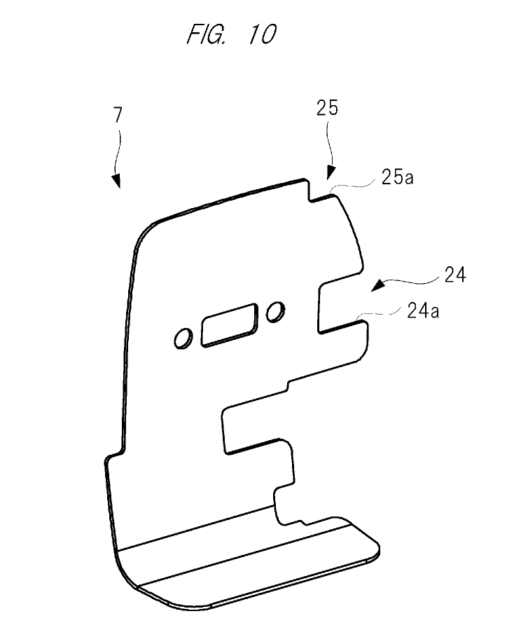

For purification and sound deadening of exhaust gas, a muffler 8 is connected to an exhaust port 3 of the cylinder 2 by screw members 52 through a divider plate 7, and the exhaust gas is discharged outside through the muffler 8. The divider plate 7 is formed of, for example, sheet-shaped material that covers steel sheet with black lead, and functions as a gasket between the muffler 8 and the exhaust port 3. The divider plate 7 is extended in a radially outward direction of the exhaust port 3 more widely than the exhaust port 3, and a cylinder cooling room 34 and a muffler cooling room 35 which are formed inside the cylinder cover 1 by the cylinder cover 1 are divided by the divider plate 7. As illustrated in FIG. 10, in the divider plate 7, a first communication port 24 is defined by a notch portion 24a and a second communication port 25 is defined by a notch portion 25a. The cylinder cooling room 34 and the muffler cooling room 35 are communicated with each other by both of the first communication port 24 and the second communication port 25.

The muffler 8 is formed in a substantially box shape, and includes an exhaust entrance and an exhaust exit 14 which are attached to the exhaust port 3. As illustrated in FIG. 5, a divider plate 15 that divides inner spaces is provided inside the muffler 8, and a catalyst 16 is attached to the divider plate 15 by weld. The catalyst 16 purifies exhaust gas by combusting harmful components in the exhaust gas.

As illustrated in FIG. 2, when a projecting side of the driving shaft 21 is a front of the engine 100, the air cleaner 6 is disposed on the right side of the engine 100 and the muffler 8 is disposed on the left side of the engine 100. The fuel tank 5 is disposed below the engine 100.

As illustrated in FIG. 2, a muffler cover 36 that covers at least some of the muffler 8 is provided around the muffler 8, and the muffler 8 is housed inside the muffler cover 36. The muffler cover 36 includes a first muffler cover 11 that is disposed opposed to the muffler 8, a second muffler cover 12 that is disposed opposed to the first muffler cover 11 and outside the first muffler cover 11, and a third muffler cover 13 that is disposed at the exhaust exit 14 side of the second muffler cover 12.

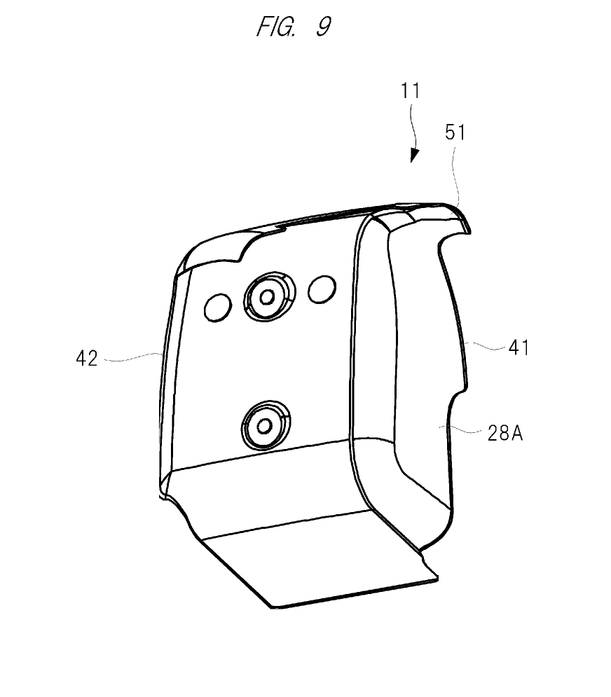

The first muffler cover 11 is formed of metal such as aluminum and steel. As illustrated in FIGS. 5 and 9, the first muffler cover 11 is formed in substantially a box shape such that the right side surface and the rear side surface are open, and in particular, includes a left wall portion opposed to the left side surface of the muffler 8 and a front wall portion opposed to the front side surface of the muffler 8 that is a cooling fan side. As described later, the front wall portion includes an air guiding portion 28A that guides cooling air to the exhaust exit side.

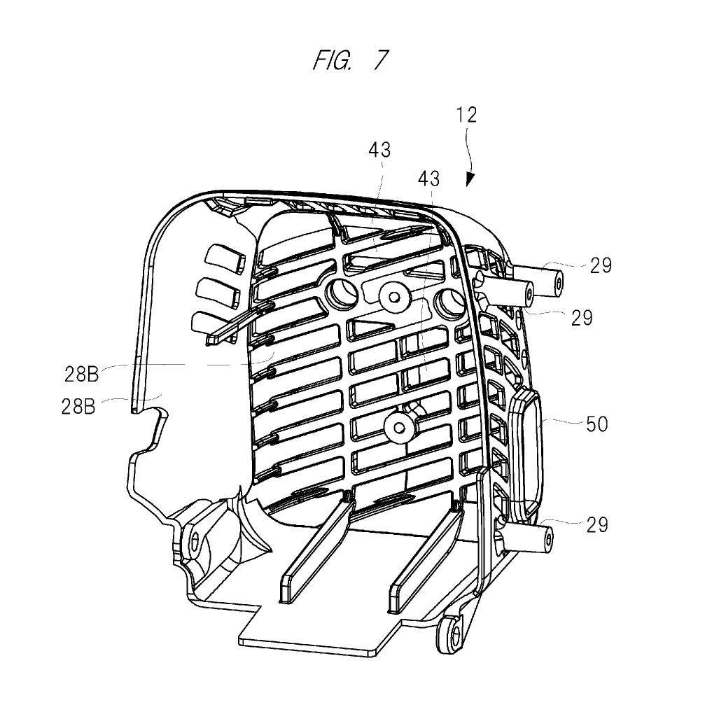

The second muffler cover 12 is formed of resin having heat resistance. As illustrated in FIG. 7, the second muffler cover 12 is formed in substantially a box shape such that one face is open, and the second muffler cover 12 is attached to the cylinder cover 1 in a state that the open face is directed to the cylinder 2. A surface of the second muffler cover 12 is formed in a netlike shape by a plurality of ribs. A wall surface is provided between adjacent ribs so as to reduce leakage of cooling air to the outside and effectively guide the cooling air, and through-holes are provided between some of the adjacent ribs as air windows 43. That is, the second muffler cover 12 includes air guiding portions 28B for cooling air at the left side surface and the front side surface. Further, at the rear side surface of the second muffler cover 12, an air exhaust port 50 is formed at a position corresponding to the exhaust exit 14 of the muffler 8 as an opening.

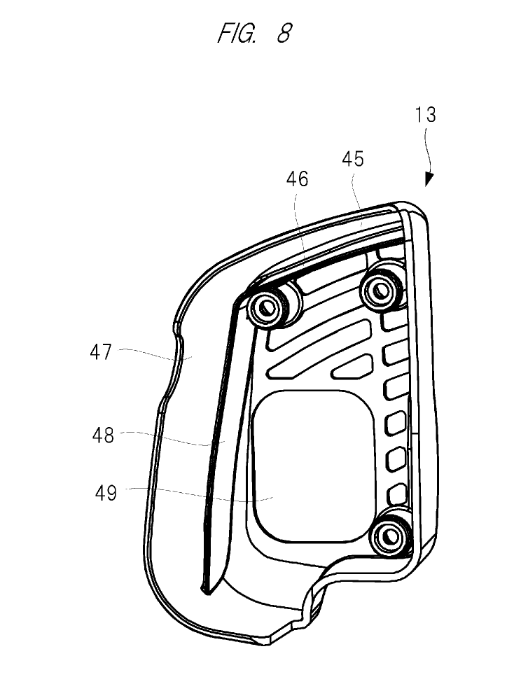

The third muffler cover 13 is formed of resin having heat resistance. As illustrated in FIG. 8, the third muffler cover 13 is formed in a box shape such that one face is open as in the second muffler cover 12, and the third muffler cover 13 is attached to the rear side surface of the second muffler cover 12 in a state that the open face is directed to the rear side surface of the muffler 8. As illustrated in FIG. 7, screw boss portions 29 having female screws are provided at rear side wall portions of the second muffler cover 12. The third muffler cover 13 is attached to the rear side surface of the second muffler cover 12 by screwing screw members 44 illustrated in FIG. 1 and coupling the screw members to the screw boss portions 29. Further, at the rear side surface of the third muffler cover 13, an opening 49 is formed at a position corresponding to the exhaust exit 14 of the muffler 8, as in the second muffler cover 12.

The first muffler cover 11 is fastened to the second muffler cover 12 by the screw members 37, and the third muffler cover 13 is fastened to the second muffler cover 12 by the screw members 44. As illustrated in FIG. 5, an outside wall of the third muffler cover 13, that is, a left-side wall portion 47 is formed so as to cover some of the left wall portion on the exhaust exist 14 side of the second muffler cover 12. The first muffler cover 11 has a side wall opposed to the muffler 8, and a first space 32A is formed between the first muffler cover 11 and the muffler 8. The first muffler cover 11 is not in contact with the muffler 8. Aside from the second muffler cover 12, the first muffler cover 11 may commonly be attached by screw members that attach the muffler 8 and the cylinder 2. In this case, it is preferable to form the first space 32A between the first muffler cover 11 and the muffler 8 by using a spacer, etc., thereby attaching the first muffler cover 11 and the muffler 8 to the cylinder 2. Further, a second space 32B is formed between the first muffler cover 11 and the second muffler cover 12. The first muffler cover 11 and the second muffler cover 12 are in contact with each other only at fasting portions by the screw members 37.

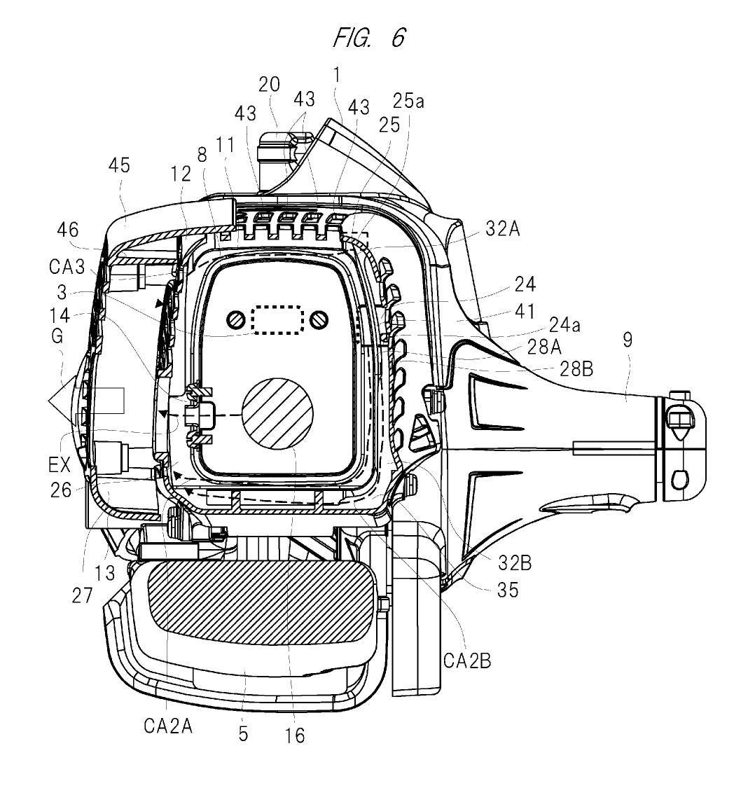

As described above, the muffler cooling room 35 is divided into the first space 32A and the second space 32B by the first muffler cover 11. A small clearance is formed between the third muffler cover 13 and the second muffler cover 12, and the third muffler cover 13 and the second muffler cover 12 are in contact with each other only at fasting portions by the screw members 44. In a state that the divider plate 7 and the first muffler cover 11 are assembled, the notch portion 24a formed in the divider plate 7 and an end portion 41 of the first muffler cover 11 are intersected with each other in a directional view vertical to a divider plate illustrated in FIG. 6. Accordingly, the notch portion 24a is disposed ranging over both of the first space 32A and the second space 32B. Further, the notch portion 25a is located within a range of the first muffler cover 11. Therefore, the first communication port 24 communicates with an inside and an outside of the first muffler cover 11. In other words, the first communication port 24 is connected ranging over each of a first cooling air entrance 31A and a second cooling air entrance 31B, and the cylinder cooling room 34, each of the first space 32A and the second space 32B are communicated by the divider plate 7. Internal spaces of the second muffler cover 12 are divided into the first space 32A and the second space 32B, the first space 32A formed between the first muffler cover 11 and the muffler 8, the second space 32B formed between the first muffler cover 11 and the second muffler cover 12. Further, in a first mixture space 26, the first space 32A and the second space 32B are communicated with each other through at least the front side surface and the left side surface of the muffler 8. Note that the cooling air passing through the second communication port 25 more flows into the first space 32A at an upper dead point of the cylinder than the first communication port 24.

The cooling fan 18 is disposed at one end portion of the driving shaft 21, that is, at a tip portion of the driving shaft 21, and the cooling fan 18 is housed in a fan case 9. As illustrated in FIG. 4, the fan case 9 is formed in a volute shape such that the distance from a center of the cooling fan 18 is gradually larger toward the cylinder 2 side, and when the driving shaft 21 (cooling fan 18) rotates in an anticlockwise direction, cooling air CA is generated toward the cylinder 2.

As illustrated in FIGS. 4 and 5, the ignition device 19 is attached to the cylinder 2 so as to be opposed to the cooling fan 18. A magnetic body (not illustrated) is housed in the cooling fan 18. The ignition device 19 generates electric power by rotation of the magnetic body (not illustrated) along with the cooling fan 18. As described above, the ignition plug (not illustrated) emits sparks inside the cylinder 2 by electric power generated by the ignition device 19. Further, as illustrated in FIGS. 3 and 5, a start-up device 38 is provided on the other end side of the driving shaft 21, that is, at a rear end portion side in a driving shaft direction. A holding portion 39 is provided in the start-up device 38. A clutch mechanism (not illustrated) is housed in the start-up device 38; therefore, an operator can manually start the driving shaft 21 by pulling the holding portion 39.

As illustrated in FIG. 5, a piston 17 is housed inside the cylinder 2 and the crankcase 4. The piston 17 and the driving shaft 21 are connected with each other through the clutch mechanism (not illustrated), and the piston 17 is reciprocated inside the cylinder 2 by rotation of the driving shaft 21. Therefore, an operator operates the holding portion 39 to rotate the driving shaft 21, thereby reciprocating the piston 17, and the air-fuel mixture is combusted by compressing the air-fuel mixture and emitting sparks inside the cylinder 2. As a result, it is possible to start the engine 100. When the engine 100 is started, the cylinder 2 and the muffler 8 increase in temperature due to the combustion and the heat of exhaust gas, and the increase in temperature is reduced by cooling air that is generated by rotation of the cooling fan 18.

Hereinafter, cooling of the cylinder 2 will be described. In FIG. 4, cooling air CA1 is generated when the driving shaft 21 (cooling fan 18) rotates anticlockwise. The cooling air CA1 flows from the bottom to the top toward the cylinder 2. The cylinder 2 is housed in the cylinder cooling room 34 formed by the cylinder cover 1 and the divider plate 7. As illustrated in FIG. 5, the cooling air CA1 flows in a horizontal direction while cooling the cylinder 2, and the cooling air CA1 is exhausted from an air window 40 provided in the cylinder cover 1.

Hereafter, cooling of the muffler 8 will be described. In FIG. 4, the cooling air CA1 is generated when the driving shaft 21 (cooling fan 18) rotates anticlockwise, and some of the cooling air CA1 is supplied to the muffler cooling room 35 from the first communication port 24 and the second communication port 25 which are provided in the divider plate 7. At this time, in the muffler cooling room 35, the first communication port 24 and the second communication port 25 are provided on the side closest to the cooling fan 18, and on the cooling fan 18 side, the cooling air is divided by the cylinder 2, thereby supplying fresh cooling air before cooling of the cylinder 2, that is, the cooling air of which the temperature is not increased to the muffler cooling room 35.

As illustrated in FIGS. 5 and 6, in the muffler cooling room 35, the end portion 41 of the first muffler cover 11 is disposed opposed to the first communication port 24. By the end portion 41, the cooling air is divided into first cooling air CA2A that flows in the first space 32A and second cooling air CA2B that flows in the second space 32B. In other words, some of the cooling air flowing into the muffler cooling room 35 from the cylinder cooling room 34 through the first communication port 24 is guided into the first cooling air entrance 31A from the first communication port 24, and other of the cooling air is guided into the first cooling air entrance 31B from the first communication port 24 in a similar manner. Further, the second communication port 25 is covered with the first muffler cover 11, and all of the third cooling air CA3 supplied from the second communication port 25 to the muffler cooling room 35 flow into the first space 32A by a guide portion 51 formed as a portion of the first muffler cover 11.

In the first space 32A, the first cooling air CA2A flows toward the exhaust exit 14, while cooling a surface of the muffler 8 by the air guiding portion 28A provided in the first muffler cover 11.

In the second space 32B, the second cooling air CA2B flows toward the exhaust exit 14, while cooling an outer surface of the first muffler cover 11 and an inner surface of the second muffler cover 12 by the air guiding portion 28B provided in the second muffler cover 12. In this way, the respective air guiding portions 28A and 28B guide the cooling air to the exhaust exit side of the muffler 8. In the first space 32A and the second space 32B, the cooling air flows in substantially the same direction.

Note that, as illustrated in FIG. 7, a plurality of air windows 43 are provided in the second muffler cover 12 besides the air guiding portions 28B, and it is therefore possible to prevent heat accumulation in the second space 32B during the operation of the engine 100 and after stopping the engine 100.

In the first muffler cover 11, an end portion 42 is extended in a direction substantially identical with an opening direction of the exhaust exit 14, while the exhaust exit 14 side is open. A clearance is formed between the exhaust exit 14 side of the end portion 42 and the second muffler cover 12, and the first mixture space 26 is formed through the clearance. Therefore, as illustrated in FIG. 5, as to the first cooling air CA2A that flows out from a first cooling-air exit 33A formed between the end portion 42 and the first muffler cover 11, the second cooling air CA2B that flows out from a second cooling-air exit 33B formed between the end portion 42 and the second muffler cover 12 and exhaust gas EX that flows out from the exhaust exit 14, the first cooling air CA2A, the second cooling air CA2B and the exhaust gas EX are mixed with each other when flowing into the first mixture space 26, and the air temperature is equalized.

Therefore, as to the first cooling air CA2A and the exhaust gas EX of which the air temperatures are remarkably increased after cooling of a surface of the muffler 8, the first cooling air CA2A and the exhaust gas EX do not run into a wall surface of the second muffler cover 12 while keeping the increased temperatures, and it is possible to effectively reduce the heat damages such as erosion, of the second muffler cover 12.

The third muffler cover 13 is further provided on the exhaust exit 14 side of the second muffler cover 12. The third muffler cover 13 covers at least some of the mixture space side of the second muffler cover 12 through a clearance, thereby forming a second mixture space 27 between the second muffler cover 12 and the third muffler cover 13. In this way, since the second mixture space 27 is formed by the third muffler cover 13, the air temperature is further equalized in the mixture gas G including the first cooling air CA2A, the second cooling air CA2B, the third cooling air CA3 and the exhaust gas EX. Therefore, the local high-temperature portions of air temperature are eliminated. This enables the heat damages in the second muffler cover 12 and the third muffler cover 13 to be effectively reduced. Further, in the third muffler cover 13, since a divider wall 48 that forms the second mixture space 27 is provided inside the sidewall portion 47 and a divider wall 46 that is communicated into the divider wall 48 is provided inside an upper wall portion 45, the mixture gas G is not in contact with the sidewall portion 47 and the upper wall portion 45, and it is possible to effectively reduce the surface temperatures in the sidewall portion 47 and the upper wall portion 45.

Since the divider plate 7 includes the second communication port 25 that allows the cylinder cooling room 34 and the second space 32B to communicate with each other and since the cooling air is supplied to at least the second space 32B, the air not directly in contact with the muffler 8 can be directed in an exhaust direction of exhaust gas in the muffler 8. It is therefore possible to reduce the temperature around the muffler 8 more effectively.

When the cooling air is supplied to both of the first space 32A and the second space 32B, even though the first muffler cover 11 increases in temperature by the first cooling air of which the temperature is increased after cooling of the muffler 8 in the first space 32A, the first muffler cover 11 can be cooled by the second cooling air flowing in the second space 32B. This enables interruption of cooling of the muffler, which is caused by heat accumulation in the first muffler cover 11, to be reduced. This also enables an increase in temperature in the second muffler cover 12 to be reduced more effectively. For example, when the first cooling air CA2A flows toward an upstream side of the second cooling air CA2B, the first cooling air CA2A of which the temperature is increased after cooling of the muffler flows to an upstream side of the second cooling air CA2B in the first muffler cover 11, so that the temperature is increased in the upstream side of the second cooling air CA2B. Therefore, at the entrance, the second cooling air CA2B increases in temperature by the first muffler cover 11, resulting in deterioration of the cooling effects.

In the first space 32A and the second space 32B, the cooling air flows in substantially the same direction, therefore, the first cooling air CA2A and the second cooling air CA2B of which the temperatures are increased after cooling of the muffler 8 and the first muffler cover 11 do not flow toward the other upstream side, and it is possible to obtain high cooling effects. For example, when the first cooling air CA2A flows toward an upstream side of the second cooling air CA2B, the first cooling air CA2A of which the temperature is increased after cooling of the muffler flows to an upstream side of the second cooling air CA2B in the first muffler cover 11, so that the temperature is increased in the upstream side of the second cooling air CA2B. Therefore, at the entrance, the second cooling air CA2B increases in temperature by the first muffler cover 11, resulting in deterioration of the cooling effects.

Since there is provided the mixture space 26 that allows the first cooling-air exit 33A and the second cooling-air exit 33B to communicate with each other, the air temperature can be equalized by mixing the first cooling air CA2A of which the temperature is further increased in the mixture space 26 and the second cooling air CA2B having a lower temperature than that of the first cooling air CA2A. This enables a local increase in temperature by the first cooling air CA2A to be reduced. It is therefore possible to effectively reduce the heat damages such as erosion, of the second muffler cover 12. Further, the temperature in the muffler cooling air exhausted from the second muffler cover 12 can be reduced.

Since the exhaust exit 14 of the muffler 8 is communicated with the mixture space 26, the exhaust gas can be mixed with the first cooling air CA2A and the second cooling air CA2B. This enables a temperature of the exhaust gas to be reduced. Since the first communication ports 24 and 25 are disposed on the cooling fan side in a driving shaft direction and since the first cooling air entrance 31A and the second cooling air entrance 31B are also disposed on the cooling fan side, the cooling air can be readily removed from the cooling fan 18, and it is possible to readily increase air volume of the first cooling air and the second cooling air.

Since the cylinder cooling room 34 is communicated with the first space 32A and the second space 32B through the common notch portion 24a provided in the divider plate 7, it is possible to improve cooling efficiency with a simple structure. Further, since cooling air before cooling of the cylinder 2 is supplied to the muffler cooling room 35, the colder cooling air can be supplied to the muffler cooling room 35, and it is possible to obtain high cooling effects.

Since the first muffler cover 11 is attached to the second muffler cover 12, the first muffler cover 11 is not directly in contact with the muffler 8, and it is possible to effectively reduce an increase in temperature in the first muffler cover 11. Since the third muffler cover 13 is provided in the second muffler cover 12, the third muffler cover 13 covering some of the mixture space side of the second muffler cover 12 through a clearance, volume of the mixture space 27 can be readily increased, and it is possible to further promote a mixture of the first cooling air CA2A, the second cooling air CA2B and the exhaust gas EX.

Since a local increase in temperature of the driving source is reduced, the engine working machine having the air-cooled engine mounted therein can be improved in terms of workability.

The present invention is not limited to the foregoing embodiment and various modifications and alterations can be made within the scope of the present invention. For example, in the present embodiment, the first muffler cover 11 is formed of metal, but may be formed of resin in view of an increase in temperature. Further, as to the first muffler cover 11 and the second muffler cover 12, a rib etc. extending from the second muffler cover 12 are used as an alternative to the first muffler cover 11, or it is also possible to integrally form the first muffler cover 11 and the second muffler cover 12 as a single member by adopting the first muffler cover 11 formed of resin and attaching the first muffler cover 11 to the second muffler cover 12 by welding or the like.

Further, in the present embodiment, as means for dividing the cooling air, which is provided from the first communication port 24 to the muffler cooling room 35, into the first space 32A and the second space 32B, the end portion 41 of the first muffler cover 11 is disposed opposed to the first communication port 24. However, the first communication port 24 may be divided into a communication port that is open toward the first space 32A and a communication port that is open toward the second space 32B.

1. An air-cooled engine comprising: a cylinder; a crank case that is attached to the cylinder and rotatably supports a driving shaft; a cooling fan that is attached to the driving shaft; a muffler that is attached to an exhaust port of the cylinder and exhausts exhaust gas passing inside from an exhaust exit; a fan case that covers the cooling fan; a cylinder cover that covers the cylinder to form a cylinder cooling room; and a muffler cover that covers the muffler to form a muffler cooling room, the air-cooled engine characterized in that
the muffler cover includes a first muffler cover that covers at least some of the muffler and a second muffler cover that covers at least some of the first muffler cover, and some of cooling air generated by the cooling fan is supplied to at least one of a first space between the muffler and the first muffler cover and a second space between the first muffler cover and the second muffler cover, and
an air guiding portion is provided inside the muffler cover, the air guiding portion guiding cooling air that is supplied to the first space or the second space to an exhaust exit side of the muffler.

2. The air-cooled engine according to claim 1, further comprising a second communication port that allows the cylinder cooling room and the second space to communicate with each other,
wherein the cooling air is supplied to at least the second space.

3. The air-cooled engine according to claim 2,
wherein the cooling air is supplied to both of the first space and the second space.

4. The air-cooled engine according to claim 3,
wherein the cooling air flows in substantially the same direction, in the first space and the second space.

5. The air-cooled engine according to claim 3, further comprising a communication port that allows the muffler cooling room and the cylinder cooling room to communicate with each other on one end side, and a mixture space that allows the first space and the second space to communicate with each other on the other end side of the muffler cooling room.

6. The air-cooled engine according to claim 5,
wherein an exhaust exit of the muffler is communicated with the mixture space.

7. The air-cooled engine according to claim 5,
wherein the communication port is disposed on the cooling fan side in the driving shaft direction, and an entrance of cooling air for the first space and an entrance of cooling air for the second space are disposed on a cooling fan side.

8. The air-cooled engine according to claim 3, further comprising a divider plate that divides the muffler cooling room and the cylinder cooling room,
wherein the divider plate includes a notch portion that allows the muffler cooling room and the cylinder cooling room to communicate with each other, and the notch portion is disposed ranging over the first space or the second space in a directional view vertical to the divider plate.

9. The air-cooled engine according to claim 1,
wherein cooling air before cooling of the cylinder is supplied to the muffler cooling room.

10. The air-cooled engine according to claim 1,
wherein the first muffler cover is attached to the second muffler cover.

11. The air-cooled engine according to claim 1,
wherein a third muffler cover is provided in the second muffler cover, the third muffler cover covering at least some of a mixture space side of the second muffler cover through a clearance.

12. An engine working machine comprising the air-cooled engine of claim 1.

13. An air-cooled engine comprising: a cylinder; a crank case that is attached to the cylinder and rotatably supports a driving shaft; a cooling fan that is attached to the driving shaft; a muffler that is attached to an exhaust port of the cylinder and exhausts exhaust gas passing inside from an exhaust exit; a fan case that covers the cooling fan; a cylinder cover that covers the cylinder to form a cylinder cooling room; and a muffler cover that covers the muffler to form a muffler cooling room, the air-cooled engine characterized in that
the muffler cover includes a first muffler cover that covers at least some of the muffler and a second muffler cover that covers at least some of the first muffler cover, and some of cooling air generated by the cooling fan is supplied to both of a first space between the muffler and the first muffler cover and a second space between the first muffler cover and the second muffler cover.
